(19) United States
(12) Patent Application Publication
(10) Pub. No.: US 2019/0042390 A1
(43) Pub. Date: Feb. 7, 2019

(54) FOCUSED EXECUTION OF TRACED CODE IN A DEBUGGER

(71) Applicant: Microsoft Technology Licensing, LLC, Redmond, WA (US)

(72) Inventor: Jordi MOLA, Bellevue, WA (US)

(21) Appl. No.: 15/666,191

(22) Filed: Aug. 1, 2017

(51) Int. Cl. G06F 11/36

(52) U.S. Cl. CPC G06F 11/364; G06F 11/3664

(57) ABSTRACT

Focusing execution of traced code includes, during replay of an executable entity based on a trace file, suspending replay of the executable entity at a particular point in the replay. While suspended, user input specifying a runtime data structure existing at the particular point in the replay is received. Based on the user input, one or more code elements, within a defined search depth, are identified. These code element's execution contributed to a value of the runtime data structure at the particular execution point. The identity of the code element(s) are presented at a user interface.

### BACKGROUND

When writing code during the development of software applications, developers commonly spend a significant amount of time “debugging” the code to find runtime and other source code errors. In doing so, developers may take several approaches to reproduce and localize a source code bug, such as observing the behavior of a program based on different inputs, inserting debugging code (e.g., to print variable values, to track branches of execution, etc.), temporarily removing code portions, etc. Tracking down runtime errors to pinpoint code bugs can occupy a significant portion of application development time.

Many types of debugging applications (“debuggers”) have been developed in order to assist developers with the code debugging process. These tools offer developers the ability to trace, visualize, and alter the execution of computer code. For example, debuggers may visualize the execution of code instructions, may present code variable values at various times during code execution, may enable developers to alter code execution paths, and/or may enable developers to set “breakpoints” and/or “watchpoints” on code elements of interest (which, when reached during execution, causes execution of the code to be suspended), among other things.

An emerging form of debugging applications enable “time travel,” “reverse,” or “historic” debugging. With “time travel” debugging, execution of a program (e.g., executable entities such as threads) is recorded/traced by a trace application into one or more trace files. These trace file(s) can then be used to replay execution of the program later, for both forward and backward analysis. For example, “time travel” debuggers can enable a developer to set forward breakpoints/watchpoints (like conventional debuggers) as well as reverse breakpoints/watchpoints.

### BRIEF SUMMARY

Embodiments herein improve on “time travel” debugging experiences by providing debugger capabilities of providing focused execution of traced code. In general, focused execution of traced code enables debuggers to provide answers to “why?” questions when replaying execution of an executable entity based on data contained in a trace file. For example, while replaying execution of the entity from a trace file, the debugger may suspend execution at a point in time, such as at a breakpoint or watchpoint. There, the debugger can present various execution state, such as the values of registers, the values of variables, and/or the values of other runtime data elements. According to embodiments herein, the debugger is also enabled to take user input to select one or more of these data elements. Then, the debugger can perform an analysis to identify code elements (e.g., variables, conditions, assignment operations, etc.) that contributed to the value of the selected data element at the time of the suspension. The debugger can enable these code element(s) to be further selected of an analysis of what contributed to their value(s) and/or why they were executed. Accordingly, these embodiments enable a user to ask “why?” questions to determine what contributed to particular program state.

In some embodiments, a method for focused execution of traced code includes, during replay of an executable entity based on a trace file, suspending replay of the executable entity at a particular point in the replay. The method also includes receiving a user input specifying a runtime data structure existing at the particular point in the replay. Based on the user input, the method also includes identifying one or more code elements within a defined search depth whose execution contributed to a value of the runtime data structure at the particular execution point. The method also includes presenting an identity of the one or more code elements at a user interface.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment that facilitates time-travel recording and replay;

FIG. 2 illustrates an example timing diagram representing a portion of execution of three executable entities;

FIG. 3 illustrates an example of a trace file recorded based on the timing diagram of FIG. 2;

FIG. 4 illustrates an example of a focused execution handler; and

FIG. 5 illustrates a flowchart of an example method for providing focused execution of traced code.

### DETAILED DESCRIPTION

Embodiments herein improve on “time travel” debugging experiences by providing debugger capabilities of providing focused execution of traced code. In general, focused execution of traced code enables debuggers to provide answers to “why?” questions when replaying execution of an executable entity based on data contained in a trace file. For example, while replaying execution of the entity from a trace file, the debugger may suspend execution at a point in time, such as at a breakpoint or watchpoint. There, the debugger can present various execution state, such as the values of registers, the values of variables, and/or the values of other runtime data elements. According to embodiments herein, the debugger is also enabled to take user input to select one or more of these data elements. Then, the debugger can perform an analysis to identify code elements (e.g., variables, conditions, assignment operations, etc.) that contributed to the value of the selected data element at the time of the suspension. The debugger can enable these code element(s) to be further selected of an analysis of what contributed to their value(s) and/or why they were executed. Accordingly, these embodiments enable a user to ask “why?” questions to determine what contributed to particular program state.

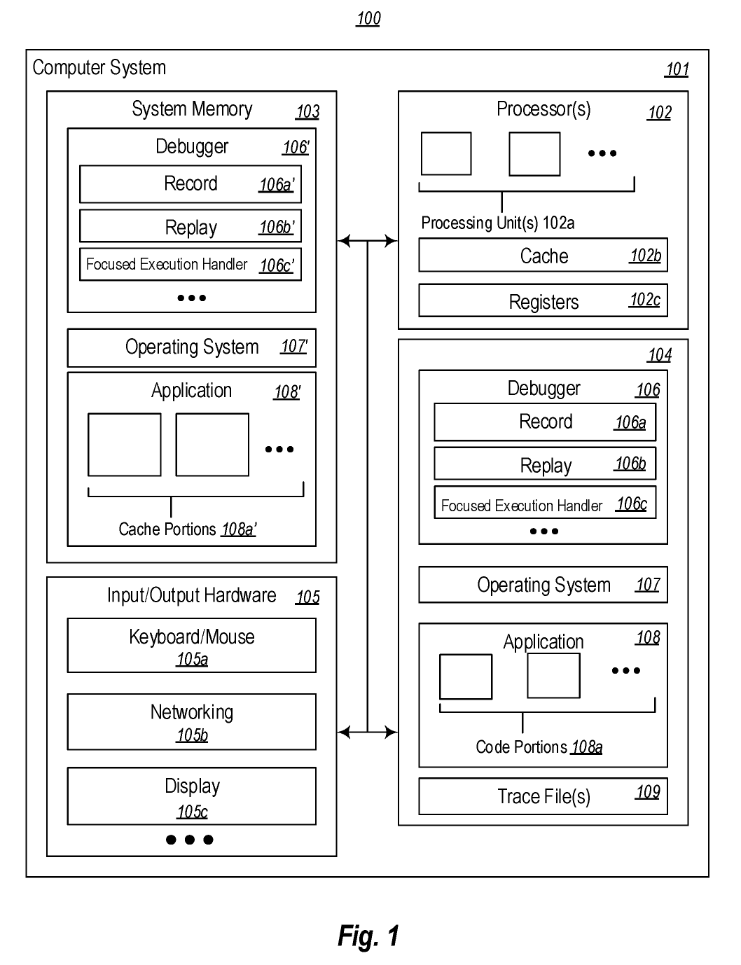

FIG. 1 illustrates an example computing environment 100 that facilitates time-travel trace recording and replay, including providing a focused execution of traced code. As depicted, embodiments may comprise or utilize a special-purpose or general-purpose computer system 101 that includes computer hardware, such as, for example, one or more processors 102, system memory 103, one or more data stores 104, and/or input/output hardware 105 (e.g., such as the depicted keyboard/mouse hardware 105a, networking hardware 105b, and display device 105c). In some embodiments, computer system 101, and the components therein, could comprise a virtualized environment.

Embodiments within the scope of the present invention include physical and other computer-readable media for carrying or storing computer-executable instructions and/or data structures. Such computer-readable media can be any available media that can be accessed by the computer system 101. Computer-readable media that store computer-executable instructions and/or data structures are computer storage devices. Computer-readable media that carry computer-executable instructions and/or data structures are transmission media. Thus, by way of example, and not limitation, embodiments of the invention can comprise at least two distinctly different kinds of computer-readable media: computer storage devices and transmission media.

Computer storage devices are physical hardware devices that store computer-executable instructions and/or data structures. Computer storage devices include various computer hardware, such as RAM, ROM, EEPROM, solid state drives (“SSDs”), flash memory, phase-change memory (“PCM”), optical disk storage, magnetic disk storage or other magnetic storage devices, or any other hardware device(s) which can be used to store program code in the form of computer-executable instructions or data structures, and which can be accessed and executed by the computer system 101 to implement the disclosed functionality of the invention. Thus, for example, computer storage devices may include the depicted system memory 103, the depicted data store 104 which can store computer-executable instructions and/or data structures, or other storage such as on-processor storage, as discussed later.

Transmission media can include a network and/or data links which can be used to carry program code in the form of computer-executable instructions or data structures, and which can be accessed by the computer system 101. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media. For example, the input/output hardware 105 may comprise networking hardware 105b (e.g., a hard-wired or wireless network interface module) that connects a network and/or data link that can be used to carry program code in the form of computer-executable instructions or data structures.

Further, upon reaching various computer system components, program code in the form of computer-executable instructions or data structures can be transferred automatically from transmission media to computer storage devices (or vice versa). For example, computer-executable instructions or data structures received over a network or data link can be buffered in RAM within networking hardware 105b, and then eventually transferred to the system memory 103 and/or to less volatile computer storage devices (e.g., data store 104) at the computer system 101. Thus, it should be understood that computer storage devices can be included in computer system components that also (or even primarily) utilize transmission media.

Computer-executable instructions comprise, for example, instructions and data which, when executed at the processor(s) 102, cause the computer system 101 to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The data store 104, which typically comprises durable storage, can store computer-executable instructions and/or data structures representing application code such as, for example, a debugger 106 (including, for example, a record component 106a, a replay component 106b, a focused execution handler 106c, etc.), an operating system 107, and an application 108 (including portions of executable code 108a of the application 108). The data store 104 can also store other types of data, such as one or more trace file(s) 109. When application code is executing (e.g., using the processor(s) 102), the system memory 103 can store corresponding runtime data, such as runtime data structures, computer-executable instructions, etc. Thus, FIG. 1 illustrates the system memory 103 as including runtime debugger data 106′ (runtime record data 106a′, runtime replay data 106b′, runtime focused execution handler data 106c′, etc.), runtime operating system data 107′, and runtime application data 108′ (including, for example, runtime variables, data structures, etc. of application 108 as it executes, as well as runtime code portions 108a′ which are in-memory copies of code portions 108a).

While the record component 106a and replay component 106b are depicted as being part of debugger 106, it will be appreciated that one more of these components could be a standalone application, or part of some other application. The record component 106a is usable to trace execution of an application, such as application 108 (including its executable code portions 108a), and to store trace data in the trace file(s) 109. The record component 106a may, in some embodiments, be integrated into the operating system 107, itself, into a hypervisor, or into some other runtime or virtualization technology. The record component 106a may also exist at an entirely different computer system to record traces at that computer system. Thus, the record component 106a may trace execution of code at the computer system; then the trace file(s) 109 resulting from that tracing can be transferred (e.g., using the networking hardware 105b) to the computer system 101 for replay by the replay component 106b. While the trace file(s) 109 are depicted as being stored in the data store 104, they may also be recorded exclusively or temporarily in the system memory 103, or at some other storage device.

FIG. 1 also includes a simplified representation of the internal hardware components of the processor(s) 102. As illustrated, each processor 102 includes processing unit(s) 102a. Each processing unit may be physical (i.e., a physical processor core) and/or logical (i.e., a logical core presented by a physical core that supports hyper-threading, in which more than one application thread executes at the physical core). Thus, for example, even though the processor 102 may in some embodiments include only a single physical processing unit (core), it could include two or more virtual processing units 102a presented by that single physical processing unit.

Each processing unit 102a executes processor instructions that are defined by applications (e.g., debugger 106, operating system 107, application code portions 108a, etc.), and which instructions are selected from among a predefined processor ISA (instruction set architecture). The particular ISA of a given processor 102 varies based on processor manufacturer and processor model. Common ISA's include the IA-64 and IA-32 architectures from INTEL, INC., the AMD64 architecture from ADVANCED MICRO DEVICES, INC., and various Advanced RISC Machine (“ARM”) architectures from ARM HOLDINGS, PLC, although a great number of other ISAs exist and can be used by the present invention. In general, an “instruction” is the smallest externally visible (i.e., external to the processor) unit of code that is executable by a processor.

Each processing unit 102a obtains processor instructions from a processor cache 102b (which may potentially be shared by the processing units 102a), and executes the processor instructions based on data in the cache 102b, based on data in registers 102c, and/or without input data. In general, the cache 102b is a small amount (i.e., small relative to the typical amount of system memory 103) of random-access memory that stores on-processor copies of portions of the system memory 103. For example, when executing the executable code portions 108a of application 108, the cache 102b stores a subset of the runtime code portions 108b′ in a code cache section of the cache 102b, and stores other runtime application data 108′ (e.g., variables, data structures, etc.) in a data cache section of the cache 102b. If the processing unit(s) 102a require data not already stored in the cache 102b, then a “cache miss” occurs, and that data is fetched from the system memory 103 (potentially evicting some other data from the cache 102b).

Registers 102c are hardware based storage locations that are defined based on the ISA of the processors(s) 102 and that are read from and/or written to by processor instructions. For example, registers 102c are commonly used to store values fetched from the cache 102b for use by instructions, to store the results of executing instructions, and/or to store status or state—such as some of the side-effects of executing instructions (e.g., the sign of a value changing, a value reaching zero, the occurrence of a carry, etc.), a processor cycle count, etc. Thus, some registers 102c may comprise “flags” that are used to signal some state change caused by executing processor instructions.

The replay component 106b replays one or more trace file(s) 109 by executing the code of the executable entity upon which the trace file(s) 109 are based at the processor(s) 102, while supplying that code with traced data (e.g., register values, memory values, etc.) from the trace file(s) 109 at appropriate times. Thus, for example, the record component 106a may record execution of one or more code portions 108a of application 108 at the processor(s) 102, while storing trace data (e.g., memory values read by code instructions, register values supplied to code instructions, etc.) in the trace files(s) 109. Then, the replay component 106b can re-execute the code portion(s) 108a at the processor(s) 102, while supplying that code with the trace data from the trace files(s) 109 so that the code is executed in the same manner that it was at trace time.

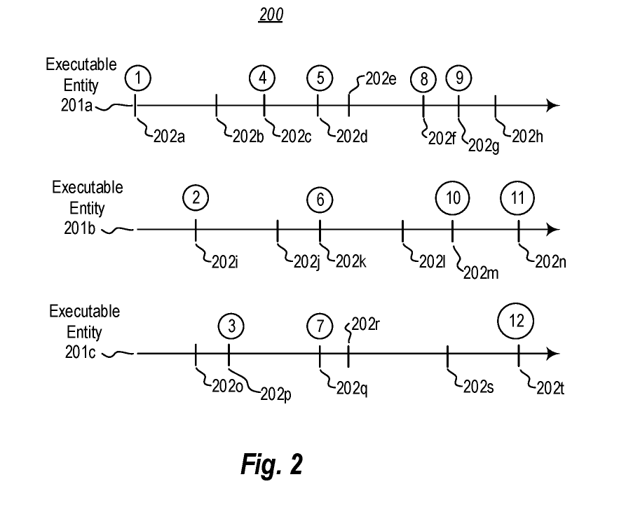

FIG. 2 illustrates an example timing diagram 200 representing a portion of execution of three executable entities 201a-201c (e.g., as observed during recording/tracing by the record component 106a), with execution commencing at the left end of the arrow, and proceeding to the right. For example, executable entities 201a-201c may correspond to threads of application 108a that execute code from one or more of code portions 108a. In another example, executable entities 201a-201c may correspond to threads of a kernel of the operating system 107. In FIG. 2, the executable entities 201a-201c execute in parallel (e.g., concurrently, each at a different physical or virtual processing unit 102a), though the embodiments herein can also operate in environments in which the executable entities 201a-201c execute “single threaded,” sharing time at a single processing unit.

In FIG. 2, individual events occur along each arrow. In general, these events correspond to individual processor instructions executed from each executable entity. Since, on modern processors, these events can easily number in the billions for mere seconds of execution, they are not expressly depicted in FIG. 2. However, FIG. 2 does identify several events occurring across the entities (i.e., events 202a-202t) that may be of particular interest to during debugging. For example, they may correspond to instructions associated with interesting memory accesses (e.g., those that would be the basis of an orderable event, and which are depicted in connection with a circled “sequencing number,” as discussed later), instructions associated with certain logical boundaries (e.g., a call to or an exit from a function, a module, a kernel transition, etc.), instructions associated with exceptions, instructions associated with cache flushes, instructions associated with input/output operations (e.g., disk accesses, network accesses, etc.), instructions associated with activity of a runtime environment (e.g., a garbage collection activity), etc. Events may also be associated with data obtained from replay of the entit(ies), such as an amount of elapsed time (e.g., “wall clock” time), an amount of processing time (e.g., processor cycles used), reaching a particular instruction count, etc. While events 202a-202t are depicted as having occurred, it is noted that the record component 106a may not actually recognize each of them as being interesting events.

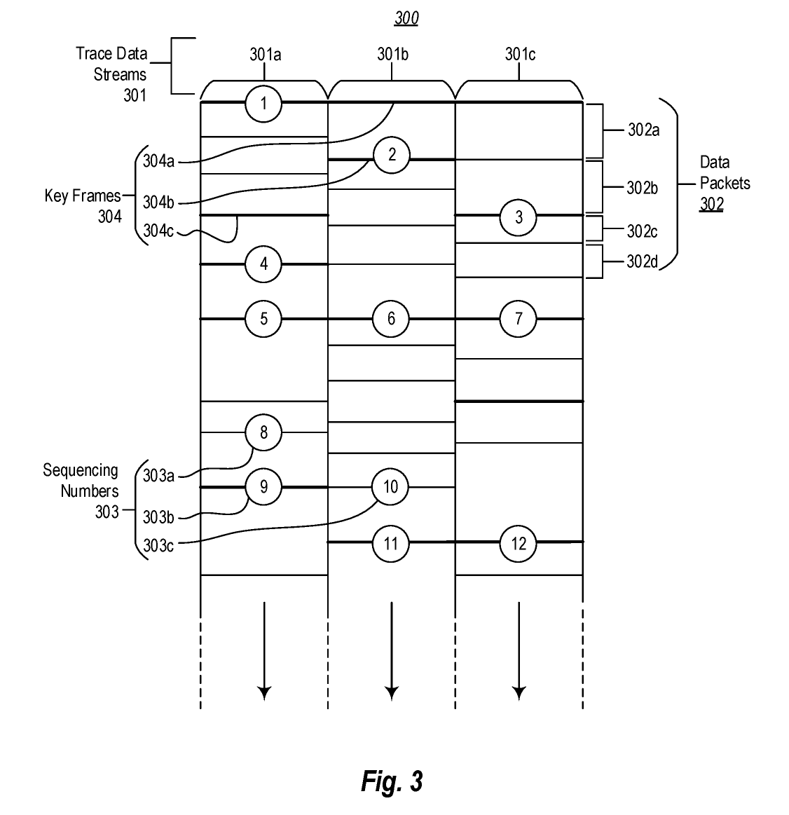

In view of FIG. 2, FIG. 3 illustrates one example of a trace file 300 that might be generated by the record component 106a based on the execution of the executable entities 201a-201c depicted in FIG. 2. In FIG. 3, which is based on a parallel execution of executable entities 201a-201c, the trace file 300 independently stores a different data stream recording data representing a different instance of execution of a code entity. Thus, in FIG. 3, the trace file 300 includes three trace data streams 301a-301c (referred to generally as trace data streams 301), each recording a trace of execution of one of executable entities 201a-201c. It will be appreciated that the trace file 300 could include any number of trace data streams 301, depending on a number of processing units 102a available at the computer system 101 and/or a number of executable entities produced by the program being traced (e.g., application 108). It will also be appreciated that the trace data streams 301 may be included in a single file trace file, or may each be stored in different related files.

Each trace data stream 301 includes a plurality of data packets storing trace data that is usable by the replay component 106b to reproduce execution of its corresponding executable entity, by supplying appropriate recorded state data (e.g., register values, memory addresses and values, etc.) to executable code of the executable entity at appropriate times. Thus, using the information in the data streams 301, and using the actual executable code of the application whose execution was traced, a full reproduction of execution of that code can be reproduced by the replay component 106b.

In some embodiments, each data packet could potentially represent the execution of a plurality of code instructions. For example, a data packet may record information that identifies a code instruction to be executed, and its inputs. Then, the replay component 106b may replay a series of instructions, where each instruction in the series is dependent only on the outputs of the prior instruction(s) to it in the series, and/or other program state (e.g., register values, memory values, etc. that were established as part of replaying prior data packet(s) in the same trace data stream 301).

One manner for recording state data in data packets of each trace data stream 301 is built upon the recognition by the inventors that processor instructions (including virtual machine “virtual processor” instructions) can generally fall into one of three categories: (1) instructions identified as “non-deterministic” as not producing predictable outputs because their outputs are not fully determined by data in general registers 102c or memory, (2) deterministic instructions whose inputs do not depend on memory values (e.g., they depend only on processor register values, or values defined in the code itself), and (3) deterministic instructions whose inputs depend on reading values from memory. Thus, in some embodiments, storing enough state data to reproduce the execution of instructions can be accomplished with solutions to three corresponding challenges: (1) how to record the non-deterministic instructions that produce output not fully determined by their inputs, (2) how to reproduce the values of input registers for instructions depending on registers, and (3) how to reproduce the values of input memory for instructions depending on memory reads.

As a solution to the first challenge, of how to record “non-deterministic” instructions of an entity that do not produce fully predictable outputs because their outputs are not fully determined by data in general registers or memory, embodiments including storing in the trace data stream 301 of an entity the side-effects of execution of such instructions. As used herein, “non-deterministic” instructions include somewhat less common instructions that (i) produce non-deterministic output each time they are executed (e.g., RDTSC on INTEL processors, which writes the number of processor cycles since the last processor reset into a register), that (ii) may produce a deterministic output, but depend on inputs not tracked by the record component 106a (e.g. debug registers, timers, etc.), and/or that (iii) produce processor-specific information (e.g., CPUID on INTEL processors, which writes processor-specific data into registers). Storing the side-effects of execution of such instructions may include, for example, storing register values and/or memory values that were changed by execution of the instruction. In some architectures, such as from INTEL, processor features such as those found in Virtual Machine eXtensions (VMX) could be used to trap instructions for recording their side effects in the trace file 300.

As a solution to the second challenge, of reproducing the values of input registers for deterministic instructions of an entity (e.g., whose inputs depend only on processor register values) is straightforward, as they are the outputs of the execution of the previous instruction(s) by the entity. Recording the execution of an entire series of processor instructions in a trace data stream 301 can therefore be reduced to reproducing the register values at the beginning of the series; the trace file 300 need not store a record of which particular instructions executed in the series, or the intermediary register values. This is because the actual instructions are available in the application's code portions 108a themselves, and which are available at replay time. These instructions can therefore be supplied the recorded inputs (i.e., the recorded initial set of register values) during reply, to execute in the same manner as they did during the trace.

As a solution to the third challenge, of reproducing the values of input memory for deterministic instructions of an entity whose inputs depend on memory values, embodiments include recording in the trace data stream 301 of the entity the memory values that the instructions in the entity consumes (i.e., its reads)—irrespective of how the values that the instructions read were written to memory. In other words, some embodiments include recording only memory reads, but not memory writes. For example, although values may be written to memory by a current thread, by another thread (including the kernel, e.g., as part of processing an interrupt), or by a hardware device (e.g., input/output hardware 105), it is just the values that the thread's instructions read that are needed for full replay of instructions of the thread that perform reads. This is because it is that values that were read by the thread (and not necessarily all the values that were written to memory) that dictated how the thread executed.

While in some embodiments, the value of each memory value read may be stored in the trace file 300, other embodiments include optimizations such as prediction techniques that attempt to predict the appropriate values without necessarily recording each read. For example, in some implementations, if the predicted value is the value that was actually read from memory, then nothing needs to be recorded in the trace file 300; however, if the predicted value does not match the value that was actually read then the value read is recorded in the trace file 300. While several prediction techniques exist, two simple prediction techniques include predicting that the next memory value read by a thread will be the same as the value previously read by the thread, or to always predict that the next memory read will have a value of zero.

FIG. 3 depicts data packets as being bounded by the horizontal lines in each data stream. Four data example packets 302 in data stream 301c are expressly labeled as data packets 302a-302d. As depicted, individual data packets may be of differing sizes, depending on trace file implementation and on the particular data stored in each packet. It will be appreciated in view of the discussion above, that data that may be included in a data packet includes information for identifying a code instruction executed (e.g., a count of instructions executed since the last logged code instruction, a processor instruction counter value, etc.), register value(s) provided to that code instruction, memory address(es)/value(s) read, any side effects of executing the code instruction (e.g., resulting register values), etc. Note that while the events in FIG. 2 are shown for clarity in relation to “wall clock” time, the data packets do not necessarily indicate the relative “wall clock” time at which different events happened.

The trace file 300 includes standard data packets (which are a depicted as beginning with a light horizontal line), as well as key frames 304 (which are a depicted as beginning with heavy horizontal lines). A key frame is a type of data packet that stores sufficient information to begin replay execution of an executable entity from the point of the key frame onward, without the need of having execution/replay state from packets prior to the key frame. For example, a key frame may store values for all relevant processor registers, information necessary to reproduce memory values from that point onward, etc.

The trace file 300 includes a key frame at the beginning of each trace data stream 301 (which enables the replay component 106b to begin replay of each trace data stream), as well as additional key frames appearing throughout each trace data steam 301. Three example key frames are expressly labeled in FIG. 3 as key frame 304a (which occurs at the beginning of trace data stream 301b), key frame 304b (which occurs in connection with an orderable event, which are discussed later), and key frame 304c. In general, the record component 106a can record a key frame at any point in a data stream 301. As depicted, they need not occur at the same time across data streams, or at any particular frequency.

As mentioned above, key frames enable the replay component 106b to initiate replay of each trace data stream 301 at various points. For example, referring to data stream 301a, the replay component 106b can use key frames to initiate execution at different parts in the stream, including at the start of the data stream, at “sequencing numbers” 4, 5, and 9 (which, as depicted, each corresponds with a key frame), and at key fame 304c. Thus, key frames define different independently repayable trace sections (or segments), with each section being bounded on both ends by a key frame.

In some embodiments, when using the example format of trace file 300, the record component 106a records each data stream 301 generally independently from the other data streams during parallel execution of the code being traced. In doing so, record component 106a does not generally record the actual timing execution of events by one entity versus the timing of execution of events by another entity, since code instructions executed by one entity generally don't affect code instructions executed by another entity. Thus, the data packets in one trace data stream 301 can generally be replayed independent of the data packets in another trace data stream 301.

The trace file 300 does, however, include some data packets identifying events that are “orderable” across the entities/data streams. These orderable events generally correspond to events that are performed by one executable entity that could affect execution of another entity, such as accessing memory shared by the entities. In FIGS. 2 and 3, orderable events are represented with a “sequencing number” that defines the relative order in which these events occurred across the entities relative to each other. Since only “orderable events” are given sequencing numbers, they provide only a partial ordering of all events recorded in the trace, as discussed later. In some embodiments, the sequencing number is a monotonically incrementing number (“MIN”)—i.e., a number that increments monotonically and that that is guaranteed to not repeat. For example, the trace file 300 includes twelve sequencing numbers (depicted as circled numerals 1-12), each defining the order in which different orderable events executed across entities 201a-201c relative to each other.

In some embodiments, orderable events are identified based on a “trace memory model” that defines whether to treat events as orderable or non-orderable based on their interactions across executable entities. For example, orderable and/or non-orderable events may be defined based on how the threads interact through shared memory, their shared use of data in the shared memory, etc. Depending on implementation, a trace memory model used by the record component 106a may be weaker or stronger than a memory model used by the processor 102. The trace memory model used may be a memory model defined by a programming language used to compile code (e.g., C++14), or some other memory model defined expressly for purposes of tracing.

A first example trace memory model may treat as orderable only kernel calls (from user mode), traps, and exceptions. This trace memory model would have low overhead, since these operations are relatively “expensive” is their own right, they are likely tracked anyway and provide a very coarse-grained overview of ordering. A second example trace memory model may treat as orderable full fences (i.e., operations that are have both acquire & release semantics). Examples of such operations may include INTEL's “locked” instructions, kernel calls, exceptions, and traps. This memory model would provide enough ordering for nearly all cross-thread communication that happens in the process when the code uses “interlocked” types of primitives to communicate cross threads, which is common in operating such as WINDOWS from MICROSOFT CORPORATION). A third example trace memory model may treat all acquires and releases as orderable. This memory model may be suitable for processors based ARM instruction sets, because ARM does not treat most loads and stores as acquires or releases. On other architectures, such as from INTEL (in which a majority of memory accesses are acquires or releases), this would equate to ordering almost all memory accesses. A fourth example trace memory model may treat as orderable all memory loads. This would provide for strong ordering but may lead to decreased performance as compared to the other example memory models. The foregoing memory models have been presented as examples only, and one of ordinary skill in the art will recognize, in view of the disclosure herein, a vast variety of memory models may be chosen.

In view of the foregoing discussion of trace file 300, it will be appreciated that key frames enable the replay component 106b to initiate replay of different sections of the same trace data stream, and thus enable the replay component 106b to replay these different sections of the same trace data stream 301 independently and in parallel. Additionally, with the trace data streams 301 being recorded independently, and with the timing of events in one trace data stream being generally independent from the timing of events in another trace data stream, the replay component 106b can replay sections from different trace data streams 301 independently and in parallel.

Sequencing numbers then enable the replay component 106b to combine the results of parallel replay of these individual sections to present an accurate representation of how the entities actually executed when they were recorded. In particular, the sequencing numbers (which, as discussed above, define the relative order of orderable events across the trace data streams, and a partial ordering of all events) enable the replay component 106b to choose an ordering among the different trace sections to define a total ordering of all instructions in the trace file 300 that can be used to present results at the debugger 106. Such an ordering enables the debugger 106 to present a consistent view of program state (e.g., memory and registers) at all points in the trace, and no matter how the replay component 106b actually arrived at that point in execution (e.g., what order in which it executed individual trace sections).

Since sequencing numbers only provide a partial ordering of events, there could be many valid orderings. In general, a valid ordering places the trace sections in an order that would ensure that sequencing events are presented in proper order (i.e., in their monotonically increasing order). However, a valid ordering does not need to reproduce the exact order in which all instructions executed relative to each other at trace time. For example, in reference to FIG. 2, a valid ordering needs to ensure that an orderable event at sequencing number 3 is presented has having occurred prior to an orderable event at sequencing number 4. However, the ordering does not need to ensure that a non-orderable event executed just after sequencing number 3 by entity 201c is presented prior to a non-orderable event executed just after sequencing number 4 by entity 201a, since these events are non-orderable events at different entities.

Valid orderings need not include sections from all trace data streams (e.g., because execution of one thread may not be relevant to obtaining desired data at a given point of interest), and multiple valid orderings could be chosen. For example, suppose that reverse breakpoint on the event at sequencing number 8 is being requested. One valid ordering of sections to reach this breakpoint using only trace data streams 301a and 301c could include:
1. A section on trace 301a starting at the key frame at sequencing number 1, and ending at an instruction just prior to the key frame at sequencing number 4, then
2. A section on trace 301c starting its beginning key frame, and ending at an instruction at the key frame at sequencing number 3, then
3. A section on trace 301a starting at the key frame at sequencing number 4, and ending at an instruction just prior to the key frame at sequencing number 5, then
4. A section on trace 301c starting at an instruction just after the key frame at sequencing number 3, and ending at an instruction just prior to the key frame at sequencing number 7, and then
5. A section on trace 301a starting at the key frame at sequencing number 5, and ending at an instruction just prior to the key frame at sequencing number 9. Note that this section includes sequencing number 8 between sequencing numbers 5 and 9.
   If these sections are viewed as having been replayed linearly, in the order specified, then all the instructions on trace 301a up to (but not including) sequencing number 9 are replayed, all of the instructions on trace 301c up to (but not including) sequencing number 7 are replayed, and each orderable event that was replayed is viewed as being replayed in the correct order (i.e., 1, 3, 4, 5, and 8).

Another valid ordering using all the trace data streams that could be chosen to arrive at sequencing event 8 could include:
1. A section on trace 301a starting at the key frame at sequencing number 1, and ending at an instruction just prior to the key frame at sequencing number 4, then
2. A section on trace 301b starting its beginning key frame, and ending at an instruction just prior to the key frame at sequencing number 2, then
3. A section on trace 301c starting its beginning key frame, and ending at an instruction just prior to the key frame at sequencing number 3, then
4. A section on trace 301b starting at the key frame at sequencing number 2, and ending at an instruction just prior to the key frame at sequencing number 6, then
5. A section on trace 301c starting at an instruction at the key frame at sequencing number 3, and ending at an instruction just prior to the key frame at sequencing number 7, then
6. A section on trace 301a starting at the key frame at sequencing number 4, and ending at an instruction just prior to the key frame at sequencing number 5, then
7. A section on trace 301a starting at the key frame at sequencing number 5, and ending at an instruction just prior to the key frame at sequencing number 9. Note again that this section includes sequencing number 8 between sequencing numbers 5 and 9.
   Similarly, if these sections are viewed has having been replayed linearly, in the order specified, all the instructions on trace 301a up to (but not including) sequencing number 9 are replayed, all of the instructions on trace 301b up to (but not including) sequencing number 6 are replayed, and all of the instructions on trace 301c up to (but not including) sequencing number 7 are replayed, and each orderable event that was replayed is viewed as being replayed in the correct order (i.e., 1, 2, 3, 4, 5, and 8).

The replay component 106b need not actually perform the replay of the sections according to this determined ordering. Instead, replay component 106b can replay the sections in any order, so long as the results obtained by the replay are presented according to the constraints of the determined ordering. Thus, the replay component 106b can queue the trace sections for replay in any order, and can replay them in any order at one or more processing units 102a, so long as the results are presented in a valid ordering.

As shown in FIG. 1, the debugger 106 may include a focused execution handler 106c. The focused execution handler 106c provides debugger functionality for providing answers to “why?” questions when replaying execution of an executable entity by the replay component 106b based on data contained in a trace file 109. For example, when replay is suspended based on hitting a breakpoint or watchpoint, or based on manual user intervention, the debugger 106 can invoke the focused execution handler 106c to provide functionality that enables a user to ask “why?” questions about program state at the point of suspension. For example, the focused execution handler 106c may provide functionality that enables the user to select a variable, a register, etc., and request an analysis as to what contributed to the value of the variable, a register, etc. In response, the focused execution handler 106c can perform an analysis to identify code elements, such as variables, assignment operations, conditionals, etc. that contributed to the value of the selected variable, a register, etc. This can then be presented to the user.

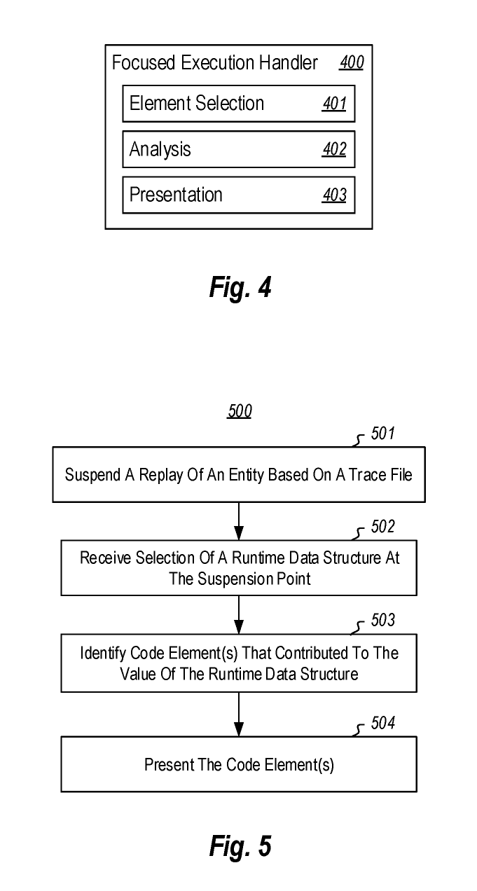

In order provide a further understanding of these concepts, FIG. 4 illustrates an example focused execution handler 400, such as focused execution handler 106c of FIG. 1. As depicted in FIG. 4, the focused execution handler 400 includes a plurality of sub-components, such as an element selection component 401, an analysis component 402, and/or a presentation component 403. The depicted identity and arrangement of sub-components 401-403 are merely one example as an aide in description, and one of ordinary skill in the art will recognize that the particular identity and number of sub-components of the focused execution handler 400 can vary greatly based on implementation.

In general, the focused execution handler 400 operates in connection with replay by the replay component 106b of a code entity (e.g., a code portion 108a) based trace data of a trace file 109. During replay, the replay component 106b may suspend code execution. This may be due to manual intervention by a user or a software component, due to hitting a defined breakpoint or watchpoint, and the like. At this time, the debugger 106 may present one or more portions of program state (e.g., the values of variables, registers 102c, etc.) as they exist at the time the code replay is suspended.

When the debugger 106 includes the focused execution handler 400, the debugger 106 may present one or more interfaces that enable one or more portions of this program state to be selected for analysis. This is represented in FIG. 4 as an element selection component 401. For example, a debugger user interface may enable a user to select one or more variables, one or more processor registers 102c, etc. from the displayed program state, and initiate an analysis of the selected element(s) (e.g., through a right-click context menu, a toolbar icon, a dropdown menu, a keyboard shortcut, etc.).

Upon this selection, the analysis component 402 of the focused execution handler 400 initiates an analysis of code execution leading up to the suspension point to identify code elements that contributed to the value of the selected element(s) at the time of the suspension. These code elements could include variables, assignment operations, conditionals, processor instructions, functions, modules, etc. As an example, suppose that code replayed up to the point of suspension includes:

...
int a = 0;
...
a = a + 1;
if (a > 0)

{b = 1;}

else

{b = 2;}

c = b + 1;

Suppose further that at the point of suspension the variable ‘b’ has the value of two. If the element selection component 401 receives the variable b as the runtime data structure of interest, the analysis component 402 could automatically identify at least four code elements that contributed to the value of b; namely, the instantiation of the variable ‘a’ (i.e., “int a=0”), the first arithmetic operation/assignment (i.e., “a=a+1; ”), the if conditional (i.e., “if (a>1)”) and the second assignment operation (i.e., “b=2”).

The analysis component 402 may conduct its analysis using one or more of several approaches. A first approach is to perform an analysis of the code portions(s) 108a to determine code execution flow, and therefore identify code elements that contributed to the value(s) of the selected elements. A second approach is to perform an analysis of the trace file(s) 109 to identify code that executed prior to the suspension point. A third approach is to utilize data gathered during the replay itself. For example, during replay by the replay component 106b, the debugger may keep records of code instructions executed, data elements used, etc. at a greater fidelity than the information recorded in the trace file(s) 109. As such, the analysis component 402 can utilize this information to identify code elements that contributed to the value(s) of the selected elements. In a variation of the third approach, the analysis component 402 may utilize the replay component 106c to perform another code replay in response to receiving the request of an analysis of the selected element(s). For example, the analysis component 402 may instruct the replay component 106b to initiate a replay at a key frame that precedes the suspension point, and track code execution, data structure usage, etc. during this replay. In this way, the debugger 106 may only track higher fidelity records of code instructions executed, data elements used, etc. during this subsequent replay.

Since the value of a portion of processor state can potentially be affected by a great number of code elements, some embodiments limit the analysis component's analysis to a defined number of elements or steps (generally starting from the most recently executed), which could be pre-defined and/or user-configurable. For example, if the number of steps is limited to two, then the analysis component 402 may only identify the two most recent steps, i.e., the if conditional (i.e., “if (a>1)”) and the second assignment operation (i.e., “b=2”).

The presentation component 403 presents the code elements identified by the analysis component 402 at a user interface. The presentation component 403 may also enable a further selection by the element selection component 401 of runtime state, in order to perform a further iterative analysis. For example, given the code snippet above and a search depth of two steps, the presentation component 403 could present the conditional (i.e., “if (a>1)”) and the assignment operation (i.e., “b=2”) as code elements that contributed to the value of b. Then, the element selection component 401 could receive a selection of the variable a, triggering further analysis by the analysis component 402 to identify the instantiation of a (i.e., “int a=θ”) and the first arithmetic operation/assignment (i.e., “a=a+1; ”). Accordingly, the focused execution handler can facilitate an iterative analysis which enables a user to progressively step back in code execution and select different data elements along the way. Thus, at each iterative step, the user can pose further “why?” questions to different targets until they potentially reach roots (i.e., an initial assignment such as “int a=θ”).

In view of the foregoing, FIG. 5 illustrates an example of a method 500 for providing focused execution of traced code. Method 500 is described in connection with FIGS. 1-4. While method 500 is presented as a series of acts, it will be appreciated that the particular number and ordering of the acts shown is only example of focused execution consistent to the embodiments herein.

As depicted, method 500 includes an act 501 of suspending a replay of an entity based on a trace file. In some embodiments, act 501 comprises, during replay of an executable entity based on a trace file, suspending replay of the executable entity at a particular point in the replay. For example, the replay component 106b can replay execution of one or more code portions 108a based on trace data stored in one or more trace file(s) 109. During this replayed execution, replay may be suspended due to manual user intervention, reaching a breakpoint or watchpoint, etc.

Method 500 also includes an act 502 of receiving selection of a runtime data structure at the suspension point. In some embodiments, act 502 comprises receiving a user input specifying a runtime data structure existing at the particular point in the replay. For example, the element selection component 401 of the focused execution handler 400/106c can receive a selection of a runtime data structure/element, such as a variable, a register, or some other data structure. In some embodiments, this selection be made based on selection of the element in a debugger user interface, and selection of an analysis operation.

Method 500 also includes an act 503 of identifying code element(s) that contributed to the value of the runtime data structure. In some embodiments, act 503 comprises, based on the user input, identifying one or more code elements within a defined search depth whose execution contributed to a value of the runtime data structure at the particular execution point. For example, the analysis component 401 of the focused execution handler 400/106c can perform one or more forms of analysis to identify code elements (e.g., assignment operations, conditionals, variable instantiations, arithmetic operations, etc.) that contributed to the value of the selected runtime data structure at the time of the suspension.

The analysis in act 503 could be based on an analysis of the actual code being executed (e.g., code portions 108a), based on an analysis of the trace data (e.g., trace files(s) 109), based on an analysis of data identified as part of the replay by the replay component 106b, based on an analysis of replay initiated by the analysis component 401, or combinations of the foregoing. Thus, act 503 could include identifying the one or more code elements from the trace file, identifying the one or more code elements based on the replay of the executable entity, and/or identifying the one or more code elements based on performing a replay in response to the user input, starting at a key frame in the trace file that is prior to the particular point in the replay.

As mentioned, the analysis can be based on a defined search depth, which limits the analysis to search a limited number of steps back. This search depth can be predefined, and/or can be received from a user. Thus, for example, method 500 could include receiving user input specifying the search depth.

The analysis can include preforming an analysis of other data elements that contributed to the selected data elements(s). In the example above, for example, the selected data element could comprise the variable b. However, the value of b is affected by the value of the variable a. Thus, the analysis component 401 could further analyze code elements that contributed to the value of a at the time that it affected b (i.e., during the if conditional). Thus, act 503 could include identifying one or more additional code elements whose execution contributed to a value of the other runtime data structure at the time of the assignment, which additional code elements could also be presented to the user.

Method 500 also includes an act 504 of presenting the code element(s). In some embodiments, act 504 comprises presenting an identity of the one or more code elements at a user interface. For example, the presentation component 403 of the focused execution handler 400/106c can present the code element(s) identified in act 503 at a debugger user interface. In some embodiments, when there are more than one code elements identified, the presentation component 403 presents them based on a temporal order in which they were executed, such as most recent to least recent.

In some embodiments, if the identified code element(s) comprise conditionals, act 504 could include identifying why the conditional was entered. For example, act 504 could include highlighting one or more variables that caused the conditional to evaluate to true, providing an indication of the value(s) of these variable(s), etc.

As indicated, the focused execution handler 400 can operate iteratively. As such, method 500 could continue with receipt of additional user input selecting a runtime data structure from the results presented in act 504, and performing an additional analysis with the analysis component 402 for this additional data structure. This could continue any number of times.

Additionally, or alternatively, the method 500 could proceed with an additional search depth. For example, once the results are presented by the presentation component 403, a user may request additional results. Thus, method 500 could include receiving user input specifying an additional search depth, identifying one or more additional code elements within the additional search depth whose execution contributed to a value of the runtime data structure at the particular execution point, and presenting an identity of the one or more additional code elements at the user interface.

Accordingly, embodiments herein provide debugger functionality for providing answers to “why?” questions when replaying execution of an executable entity. This functionality can be performed iteratively, to enable a user to drill down progressively deeper into prior code execution. This enables a user to quickly and efficiently identify code errors that lead to unexpected values.

Although the subject matter has been described in language specific to structural features and/or methodological acts, it is to be understood that the subject matter defined in the appended claims is not necessarily limited to the features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computer system, comprising:
one or more processors; and
one or more computer-readable media having stored thereon computer-executable instructions that are executable by the one or more processors to configure the computer system to focus execution of traced code, the computer-executable instructions including instructions that are executable to configure the computer system to perform at least the following:
during a first replay of an executable entity based on a trace file, suspend the first replay of the executable entity at a particular point in the replay;
receive a user input specifying a runtime data structure existing at the particular point in the replay;
based on the user input, perform a second replay of a portion of the executable entity based on the trace file in order to identify one or more code elements within a defined search depth whose execution is identified, based on the second replay, to have contributed to a value of the runtime data structure at the particular execution point; and
present an identity of the one or more code elements at a user interface.

2. The computer system of claim 1, wherein the computer-executable instructions also include instructions that are executable to configure the computer system to receive user input specifying the search depth.

3. The computer system of claim 1, wherein the one or more code elements include one or more of an assignment operation, a conditional, an instantiation operation, or an arithmetic operation.

4. The computer system of claim 1, wherein the computer-executable instructions also include instructions that are executable to configure the computer system to identify why a conditional was entered.

5. The computer system of claim 1, wherein the one or more code elements include an assignment from another runtime data structure, and wherein the computer-executable instructions also include instructions that are executable to configure the computer system to:
identify one or more additional code elements whose execution contributed to a value of the other runtime data structure at the time of the assignment; and
present an identity of the one or more additional code elements at the user interface.

6. The computer system of claim 1, wherein the one or more code elements comprise a plurality of code elements, and wherein presenting the identity of the one or more code elements at the user interface comprises presenting the plurality of code elements based on a temporal order in which they were executed.

7. The computer system of claim 1, wherein the one or more code elements are identified from the trace file.

8. (canceled)

9. The computer system of claim 1, wherein the one or more code elements are identified based on performing the second replay starting at a key frame in the trace file that is prior to the particular point in the replay.

10. The computer system of claim 1, wherein the computer-executable instructions also include instructions that are executable to configure the computer system to:
receive user input specifying an additional search depth;
identify one or more additional code elements within the additional search depth whose execution contributed to a value of the runtime data structure at the particular execution point; and
present an identity of the one or more additional code elements at the user interface.

11. A method, implemented at a computer system that includes one or more processors, for focusing execution of traced code, the method comprising:
during a first replay of an executable entity based on a trace file, suspending the first replay of the executable entity at a particular point in the replay;
receiving a user input specifying a runtime data structure existing at the particular point in the replay;
based on the user input, performing a second replay of a portion of the executable entity based on the trace file in order to identify one or more code elements within a defined search depth whose execution is identified, based on the second replay, to have contributed to a value of the runtime data structure at the particular execution point; and
presenting an identity of the one or more code elements at a user interface.

12. The method of claim 11, further comprising receiving user input specifying the search depth.

13. The method of claim 11, wherein the one or more code elements include one or more of an assignment operation, a conditional, an instantiation operation, or an arithmetic operation.

14. The method of claim 11, further comprising identifying why a conditional was entered.

15. The method of claim 11, wherein the one or more code elements include an assignment from another runtime data structure, and the method further comprising:
identifying one or more additional code elements whose execution contributed to a value of the other runtime data structure at the time of the assignment; and
presenting an identity of the one or more additional code elements at the user interface.

16. The method of claim 11, wherein the one or more code elements comprise a plurality of code elements, and wherein presenting the identity of the one or more code elements at the user interface comprises presenting the plurality of code elements based on a temporal order in which they were executed.

17. The method of claim 11, wherein the one or more code elements are identified from the trace file.

18. (canceled)

19. The method of claim 11, wherein the one or more code elements are identified based on performing the second replay starting at a key frame in the trace file that is prior to the particular point in the replay.

20. A computer program product comprising one or more hardware storage devices having stored thereon computer-executable instructions that are executable by one or more processors to configure a computer system to focus execution of traced code, the computer-executable instructions including instructions that are executable to configure the computer system to perform at least the following:
during a first replay of an executable entity based on a trace file, suspend the first replay of the executable entity at a particular point in the replay;
receive a user input specifying a runtime data structure existing at the particular point in the replay;
based on the user input, perform a second replay of a portion of the executable entity based on the trace file in order to identify one or more code elements within a defined search depth whose execution is identified, based on the second replay, to have contributed to a value of the runtime data structure at the particular execution point; and
present an identity of the one or more code elements at a user interface.

21. The computer system of claim 1, wherein the second replay keeps a higher fidelity record of code instructions executed than the first replay.

22. The method of claim 11, wherein the second replay keeps a higher fidelity record of code instructions executed than the first replay.
